(19) United States
(12) Patent Application Publication
(10) Pub. No.: US 2020/0151010 A1
(43) Pub. Date: May 14, 2020

(54) SCHEDULING OF FIXED NUMBER OF NON-SHARABLE RESOURCES

(71) Applicant: Nutanix, Inc., San Jose, CA (US)

(72) Inventors: Snehal Wadhwani, Bangalore (IN); Manish Kumar, Bangalore (IN); Ratan Kumar, Bangalore (IN); Uday Bhaskar, Bangalore (IN)

(21) Appl. No.: 16/186,488

(22) Filed: Nov. 10, 2018

(51) Int. Cl. G06F 9/48; G06F 9/50

(52) U.S. Cl. CPC G06F 9/4887; G06F 9/5011

(57) ABSTRACT

An aspect of the present disclosure is directed to scheduling of a fixed number of non-sharable resources. In one embodiment, a schedule data specifying respective durations in which a non-sharable resource is allocated to corresponding sets of users is maintained. A check is performed in a duration (between start and end time instances) whether the non-sharable resource is being used by a set of users specified in the schedule data. The non-sharable resource is deallocated from the set of users within the duration if checking determines that the non-sharable resource is not being used by the set of users. Accordingly, the non-sharable resource is made available for allocation before the end time instance.

### BACKGROUND OF THE DISCLOSURE

### Technical Field

The present disclosure relates to server systems, and more specifically to scheduling of fixed number of non-sharable resources.

### Related Art

A resource refers to a thing that can be used by users. The resources can be physical resources such as a meeting room, projector, laboratories, sports arena, etc., or electronic resources such as applications, files, licenses, etc.

Many resources are non-sharable, implying that a resource can be used by utmost one user at any point of time. Thus, when a user is using a resource, all the other users are blocked from using the same resource. Often only a fixed number (i.e., count) of resources are available for usage among many users.

Scheduling approaches are therefore commonly used to permit multiple users to use such non-sharable resources. In such approaches, different users are scheduled to use a resource in different non-overlapping durations. Thus, scheduling operates to allocate a non-sharable resource to a user thereby blocking all the other users. Only upon the resource being deallocated from the user, any of the other users can use the resource.

Aspects of the present disclosure are directed to scheduling of such fixed number of non-sharable resources.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which scheduling of fixed number of non-sharable resources is performed according to an aspect of the present disclosure.

FIG. 3A depicts portions of a resource data that specifies the details of non-sharable resources in one embodiment.

FIG. 3B depicts portions of a schedule data that specifies respective durations in which non-sharable resources are allocated to corresponding sets of users in one embodiment.

FIG. 4A is a state diagram for a non-sharable resource in one embodiment.

FIG. 4B is a timing diagram illustrating the manner in which scheduling of fixed number of non-sharable resources is performed in one embodiment.

FIG. 5 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

1. Overview

An aspect of the present disclosure is directed to scheduling of a fixed number of non-sharable resources. In one embodiment, a digital processing system maintains a schedule data specifying respective durations in which a non-sharable resource is allocated to corresponding sets of users. The system checks in a duration (between start and end time instances) whether the non-sharable resource is being used by a set of users specified in the schedule data. The system then deallocates the non-sharable resource from the set of users within the duration if the system determines that the non-sharable resource is not being used by the set of users. Accordingly, the non-sharable resource is made available for allocation before the end time instance.

According to another aspect of the present disclosure, the schedule data noted above further specifies a wait duration for the set of users. As such, the system performs the deallocating after elapsing of the wait duration from the start time instance.

According to one more aspect of the present disclosure, the system determines that the non-sharable resource is being used by a specific set of users. The system then deallocates the non-sharable resource if the specific set of users does not have any users in common with the set of users specified by the schedule data.

According to yet another aspect of the present disclosure, the system receives a corresponding heartbeat signal indicating that the non-sharable resource is being used at a respective time instance. The system then determines that the non-sharable resource is not being used if the corresponding heartbeat signal is not received at a specific time instance in the duration. In one embodiment, the system also receives data indicating a specific set of users using the non-sharable resource at the respective time instance. The system then determines that the non-sharable resource is not being used if the specific set of users does not match the first set of users.

According to an aspect of the present disclosure, the system receives the corresponding heartbeat signal and the data indicating the specific set of users from an IoT (Internet of things) device associated with the non-sharable resource. In one embodiment, the non-sharable resource is a meeting room, with the IoT (Internet of things) device associated with the meeting room being a camera performing facial recognition.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

2. Example Environment

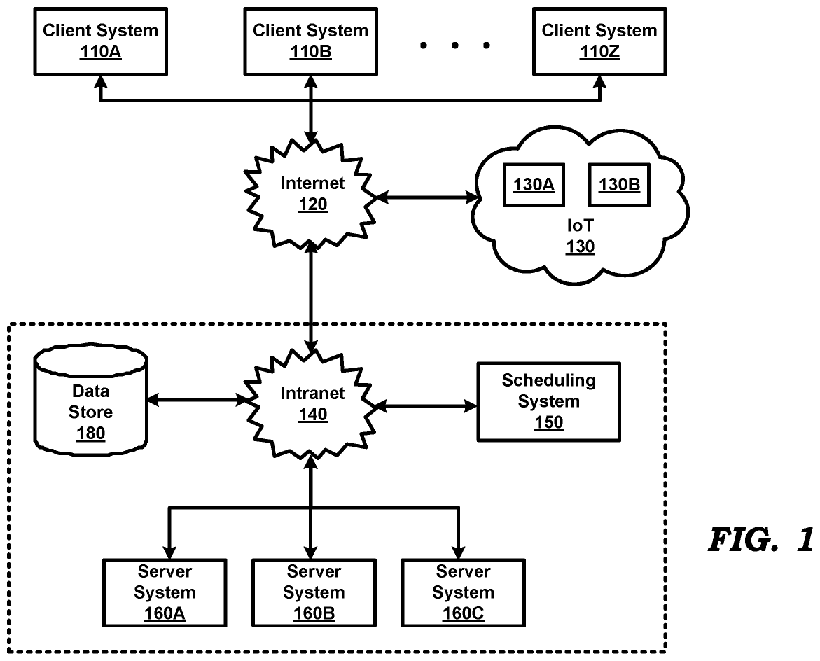

FIG. 1 is a block diagram illustrating an example environment (computing system) in which several aspects of the present invention can be implemented. The block diagram is shown containing client systems 110A-110Z, Internet 120, intranet 140, IoT (Internet of things) 130 (in turn shown containing IoT devices 130A-130B), scheduling system 150, server systems 160A-160C and data store 180.

Merely for illustration, only representative number/type of systems is shown in FIG. 1. Many environments often contain many more systems, both in number and type, depending on the purpose for which the environment is designed. Each block of FIG. 1 is described below in further detail.

Intranet 140 represents a network providing connectivity between scheduling system 150, server systems 160A-160C and data store 180, all provided within an enterprise (as indicated by the dotted boundary). Internet 120 extends the connectivity of these (and other systems of the enterprise) with external systems such as client systems 110A-110Z and IoT 130. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies a target application, the packet may be said to be directed to such application as well.

IoT 130 represents to the network of physical devices such as home appliances, vehicles and other items embedded with electronics, software, sensors, actuators, and connectivity which enable these devices to connect, collect and exchange data. Each physical device is associated with a corresponding IP address to enable the physical device to communicate with other Internet-enabled devices and systems via Internet 120. IoT devices 130A-130B represents such physical devices provided as part of IoT 130. Example of IoT devices include but are not limited to cameras with facial recognition, thermostats, smart switches/plugs, smart locks, driverless vehicles, etc.

Data store 180 represents a non-volatile (persistent) storage facilitating storage and retrieval of enterprise data by applications executing in scheduling system 150 and server systems 160A-160C. Data store 180 may be implemented as a corresponding database server using relational database technologies and accordingly provide storage and retrieval of data using structured queries such as SQL (Structured Query Language). Alternatively, data store 180 may be implemented as a corresponding file server providing storage and retrieval of data in the form of files organized as one or more directories, as is well known in the relevant arts.

Each of client systems 110A-110Z represents a system such as a personal computer, workstation, mobile device, computing tablet etc., used by users to generate (client) requests directed to enterprise applications executing in scheduling system 150 and server system 160A-160C. The client requests may be generated using appropriate user interfaces (e.g., web pages provided by an enterprise application executing in a server system, a native user interface provided by a portion of an enterprise application downloaded from server systems, etc.).

In general, an client system requests an enterprise application for performing desired tasks and receives the corresponding responses (e.g., web pages) containing the results of performance of the requested tasks. The web pages/responses may then be presented to the user by the client applications such as the browser. Each client request is sent in the form of an IP packet directed to the desired server system or enterprise application, with the IP packet including data identifying the desired tasks in the payload portion.

Each of scheduling system 150 and server systems 160A-160C represents a server, such as a web/application server, executing enterprise applications capable of performing tasks requested by users using one of client systems 110A-110Z. A server system receives a client request from a client system and performs the tasks requested in the client request. A server system may use data stored internally (for example, in a non-volatile storage/hard disk within the server system), external data (e.g., maintained in data store 180) and/or data received from external sources (e.g., from the user) in performing the requested tasks. The server system then sends the result of performance of the tasks to the requesting client system (one of 110A-110Z) as a corresponding response to the client request. The results may be accompanied by specific user interfaces (e.g., web pages) for displaying the results to the requesting user.

In one embodiment, server systems 160A-160C host a fixed number of non-sharable electronic resources such as applications, files, licenses, etc. that can be accessed by users using client systems 110A-110Z. Specifically, each server system receives client requests for accessing non-sharable resources and provides access to the requested resources as respective responses. Once a resource has been provided access to a user, the server system does not process further client requests for accessing the (same) resource until the resource is indicated to be available by the user. Such operation causes the resource to be non-sharable, and accessed by only one user at any point of time.

Scheduling system 150 facilitates multiple users to use such non-sharable resources hosted on server systems 160A-160C. In particular, scheduling system 150 receives schedule requests specifying corresponding (non-overlapping) durations in which user(s) wish to access specific resources, allocates the specific resources for the requested duration if the specific resources are available (that is, have not been allocated to any other user in the requested duration), and sends corresponding responses indicating the success/failure of the scheduling requests. Server systems 160A-160C operates to ensure that the resources are provided access to only the allocated user(s) in the corresponding non-overlapping durations. In one embodiment, scheduling system 150 also facilitates users to schedule and access physical resources such as meeting rooms, projectors laboratories, sports arena, etc., with the enforcement of the allocation being performed manually.

It may be appreciated that such a scheduling approach has several challenges since the resources are non-sharable and fixed/limited in number. One challenge is that the allocation of a resource to a user for a duration prevents/blocks other users from using the resource during the duration, even if the resource is not actually used by the user. Another challenge is the non-optimal usage of the resource by the user. For example, a user may always block a resource for a longer duration (e.g. 2 hours), even though the user actually uses the resources only for shorter durations (e.g. 15-45 min). In such a scenario as well, other users are prevented from using the resource during the longer duration, though the resource may be actually available much before the longer duration has elapsed.

Scheduling system 150, extended according to several aspects of the present disclosure, facilitates scheduling of fixed number of non-sharable resources while overcoming some of the challenges noted above. The manner in which scheduling system 150 facilitates scheduling of fixed number of non-sharable resources is described below with examples.

3. Scheduling Of Fixed Number Of Non-Sharable Resources

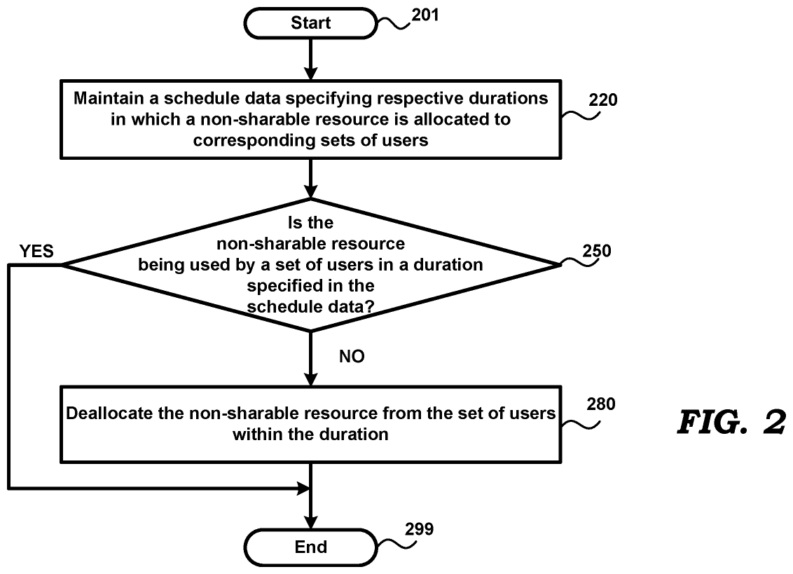

FIG. 2 is a flow chart illustrating the manner in which scheduling of fixed number of non-sharable resources is performed according to an aspect of the present disclosure. The flowchart is described with respect to the systems of FIG. 1, in particular scheduling system 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 220, scheduling system 150 maintains a schedule data specifying respective durations in which a non-sharable resource is allocated to corresponding sets of users. The schedule data may be maintained as a database/table maintained in data store 180 (implemented as a database server using relational database technologies). Alternatively, the schedule data source may be maintained in one or more files in data store 180 (when implemented as a file server).

As noted above, scheduling system 150 may receive schedule requests from client system 110A-110Z specifying corresponding (non-overlapping) durations in which user(s) wish to access the non-sharable resource and then update the schedule data based on the allocation of the non-sharable resource to the user(s).

In step 250, scheduling system 150 checks whether the non-sharable resource is being used by a set of users in a duration specified in the schedule data. The checking of the usage is performed according to the type of the non-sharable resource. According to one aspect, scheduling system 150 receives corresponding heartbeat signal indicating that the non-sharable resource is being used at a respective time instance.

In the scenario that the non-sharable resource is an electronic resource, the heartbeat signals may be received from a system (such as one of server systems 160A-160C controlling access to the resource) associated with the electronic resource. In the scenario that the non-sharable resource is a physical resource, the heartbeat signals may be received from an IoT device (such as 130A-130B) associated with the non-sharable physical resource. Scheduling system 150 then determines that the non-sharable resource is not being used if the corresponding heartbeat signal is not received at a specific time instance in the duration specified in the schedule data.

In one embodiment, scheduling system 150 also receives data indicating a specific set of users using the non-sharable resource at the respective time instance. In the case of a physical resource, the IoT device associated with the physical resource may have the capability to determine the specific set of users. For example, a camera performing facial recognition (IoT device) located/placed in a meeting room (physical resource) may provide the heartbeat signals and the specific set of users using the physical resource.

Scheduling system 150 then determines that the non-sharable resource is not being used if the specific set of users does not match the set of users specified by the schedule data, that is, if the specific set of users does not have any users in common with the set of users specified by the schedule data. Control passes to step 280 if scheduling system 150 determines that the non-sharable resource is not being used by the set of users in the duration specified by the schedule data and to step 299 otherwise.

In step 280, scheduling system 150 deallocates the non-sharable resource from the set of users within the duration. Deallocating the non-sharable resource implies that the non-sharable resource is made available for allocation to other users within the duration. As such, if the non-sharable resource is not actually being used by the set of users during the duration, the non-sharable resource is unblocked prior to the expiry of the duration. The flowchart ends in step 299.

According to an aspect of the present disclosure, scheduling system 150 performs the steps 250 and 280 after the elapsing of a wait duration (e.g. 15 minutes) specified by the schedule data for the set of users (noted above). The wait duration may be dynamically determined based on the prior usage of the non-sharable resource by the set of users, the prior usage of resources of similar types by the set of users, etc. For example, if the non-sharable resource has been deallocated within the duration for the set of users, a smaller wait duration may be specified in the schedule data when the same resource is allocated for another duration to the same set of users. As such, the non-optimal usage of the non-sharable resource by the set of users may be avoided.

The manner in which scheduling system 150 facilitates scheduling of fixed number of non-sharable resources according to the operation of FIG. 2 is illustrated below with examples.

4. Illustrative Example

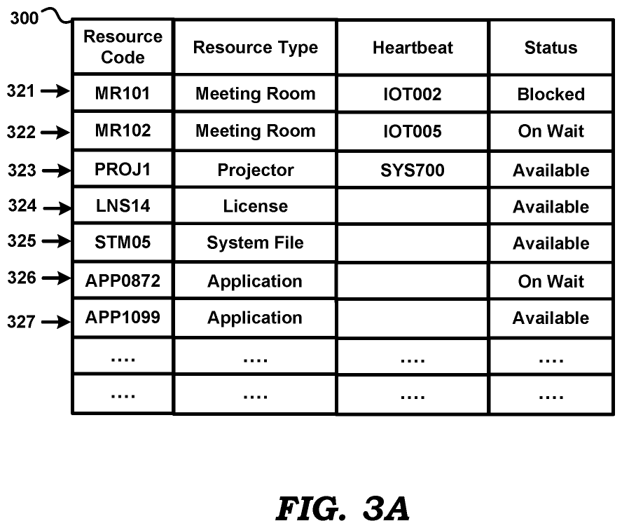

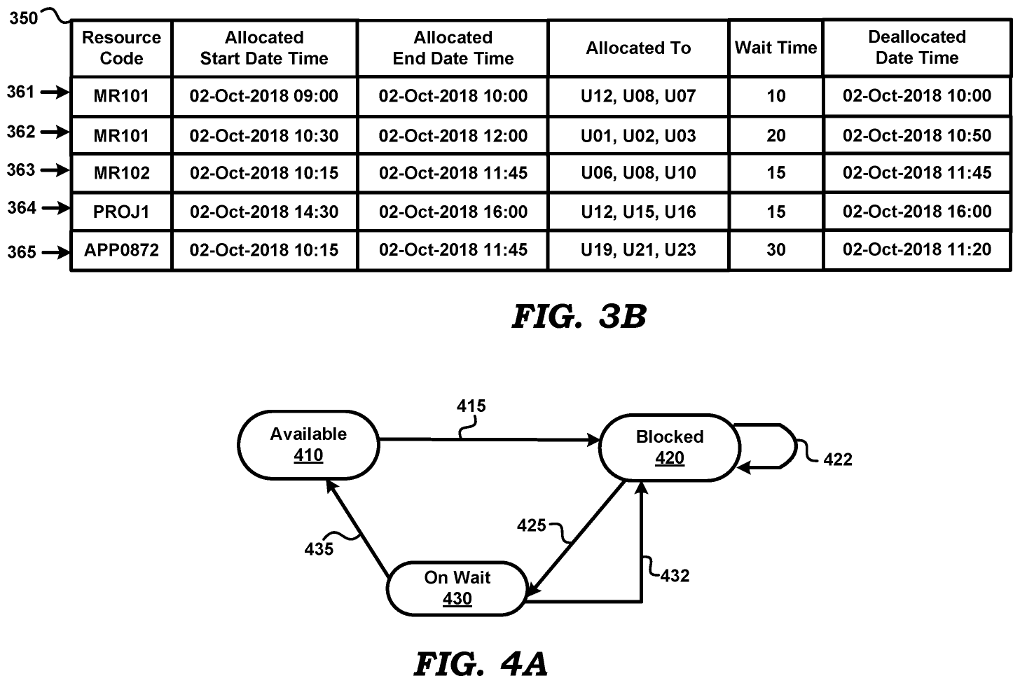

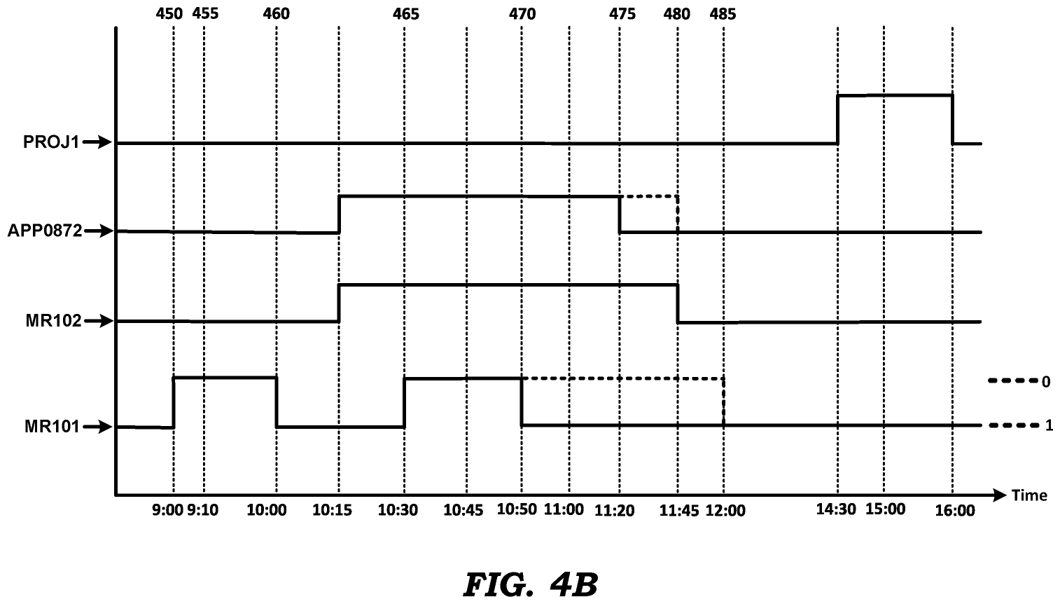

FIGS. 3A-3B and 4A-4B together illustrate the manner in which scheduling of fixed number of non-sharable resources is performed in one embodiment. Each of the Figures is described in detail below.

FIG. 3A depicts portions of a resource data that specifies the details of non-sharable resources in one embodiment. Though shown maintained in the form of a table (in data store 180), the resource data (as well as the schedule data of FIG. 3B) may be maintained according to other data formats (such as extensible markup language (XML), etc.) and/or using other data structures (such as lists, trees, etc.), as will be apparent to one skilled in the relevant arts by reading the disclosure herein.

Table 300 depicts a portion of the resource data. Specifically, column “Resource Code” specifies a unique code associated with each non-sharable resource, column “Resource Type” specifies a type of the non-sharable resource such as “Meeting”, “Application”, etc., column “Heartbeat” specifies an identifier of the system/IoT device from which heartbeat signals are received for the non-sharable resource and column “Status” indicates the status (“Blocked”, “On Wait” or “Available”) of the non-sharable resource.

Each of rows 321-327 specifies the details of a corresponding non-sharable resource. While rows 321-323 specify the details of physical resources, rows 324-327 specify the details of electronic resources. In particular, row 321 specifies the details of a non-sharable resource of type “Meeting Room” having the unique code “MR101”, whose heartbeat is received from an IoT device IOT002 (assumed to be the identifier of IoT device 130A) and whose current status is “Blocked”. As noted above, IoT device IOT002 may be placed/located associated with the meeting room MR101. Similarly, the other rows of table 300 specify the details of other non-sharable physical and electronic resources.

FIG. 3B depicts portions of a schedule data that specifies respective durations in which non-sharable resources are allocated to corresponding sets of users in one embodiment. Table 350 depicts a portion of the schedule data. Specifically, column “Resource Code” specifies the code associated with the non-sharable resource (and provides a reference to the resource in table 300) that is allocated, columns “Allocated Start Date Time” and “Allocated End Date Time” specifies the non-overlapping duration for which the resource is allocated, “Allocated To” specifies the users (indicated as U01, U02, U03, etc. for convenience) to which the resource is allocated, “Wait Time” specified the wait duration for the allocation and “Deallocated Date Time” specifies the time instance at which the resource was deallocated.

Each of rows 361-365 specifies the details of a corresponding non-sharable resource. In particular, row 361 specifies that the resource having the unique code “MR101” has been allocated for the duration between “02-Oct-2018 09:00AM” and “02-Oct-2018 10:00AM” for the users U12, U08, U07, with the wait time/duration being 10 minutes. Similarly, the other rows of table 350 specify the details of other non-sharable resources allocated to users by scheduling system 150. It may be observed that the same resource “MR101” is shown allocated to different users for different durations in rows 361 and 362, with each of the allocation having a corresponding wait time.

Scheduling system 150 facilitates the scheduling of a fixed number of non-sharable resources by using the combination of resource data and schedule data noted above. The manner in which scheduling system 150 uses such data to perform the checking and deallocating of the resources within the allocation durations is described below with examples.

5. State Diagram

FIG. 4A is a state diagram for a non-sharable resource in one embodiment. The state diagram reflects the various statuses of the non-sharable resource at a specific time instance along with the possible transitions among the states. Though shown for a single resource and a specific time instance, it should be noted that scheduling system 150 may maintain such state diagrams for each non-sharable resource (such as those specifies by rows 321-327) sought to be scheduled and keep updating the state of the resource at different time instances.

State 410 represents the “Available” status indicating that the resource is available for allocation to users. State 420 represents the “Blocked” status indicating that the resource is blocked for a set of users (for a duration) and cannot be allocated to other users. State 430 represents the “On Wait ” status indicating that the resource is not being used by the allocated set of users.

Transition 415 occurs when a schedule request for the resource is successful. In particular, scheduling system 150 upon receiving the schedule request for the resource for a duration and a set of users, first checks schedule data of table 350 to determine whether the resource is available for the duration. If the resource is available for the duration, scheduling system 150 allocates the resource to the set of users for the duration by adding a corresponding row to table 350 reflecting the allocation. As such, the resource does transition 415 from state 410 (“Available”) to state 420 (“Blocked”).

Transitions 422 and 425 occur during the allocated duration for the set of users, and respectively represent the transitions when the resource is determined to be used or not used. After the start of the allocation duration, scheduling system 150 periodically checks whether the resource is being used by the allocated set of users. The periodic checking may be performed from the start of the allocated duration at a pre-configured interval. If the resource is determined as being used, the resource has transition 422 back to the same state 420 (“Blocked”). If the resource is determined as being not used, the resource does transition 425 from state 420 (“Blocked”) to state 430 (“On Wait”), indicating that the resource is on wait (not being used).

While the resource is in state 430 (“On Wait”), scheduling system 150 continues to periodically check whether the resource is being used by the allocated set of users. If scheduling system 150 determines that the resource is being used by the allocated set of users within the wait duration/time, the resource has transition 432 from state 430 (“On Wait”) to state 420 (“Blocked”).

However, if the resource is determined to be not used even after the wait duration/time is elapsed, the resource has transition 435 from state 430 (“On Wait”) to state 430 (“Available”). It may be appreciated that when the resource is in state 420 (“Blocked”), scheduling system 150 may determine that the resource is not being used after the wait duration has elapsed, and according transitions 425 and 435 may occur consecutively to cause the resource to be in state 430 (“Available”).

Thus, the non-sharable resource is made available for allocation between the time instances (allocated start and end date times) of the allocated duration. The manner in which the above state diagram is operable for multiple non-sharable resources is described below with examples.

6. Timing Diagram

FIG. 4B is a timing diagram illustrating the manner in which scheduling of fixed number of non-sharable resources is performed in one embodiment. Specifically, FIG. 4B corresponds to the timing diagram for the scheduling shown in schedule data of FIG. 3B. It is assumed that scheduling system 150 performs the checking of whether a resource is being used at a periodic interval of 5 minutes.

Level 1 indicates that the corresponding resource is “Available” to other users, while level 0 indicates that the corresponding resource is not available (“Blocked” or “On Wait”) to other users. Thus, resource MR101 is shown as being not available between time instances 450 and 460 and being available between time instance 460 and 465.

Based on the scheduling data of FIG. 3B, scheduling system 150 determines that resource MR101 has been blocked from time instance 450, and starts to check whether the resource is being used at intervals of 5 minutes (e.g. at 9:00, 9:05, 9:10, etc.). As noted above, the checking may be performed by an IoT device (IOT002) such as a camera performing facial recognition. The duration between the time instances 450 and 455 represents the wait duration for the resource MR101 for the allocated set of users. In other words, resource MR101 is deemed to be state 430 (“On Wait”) during the duration between time instances 450 and 455.

Upon determining that resource MR101 is being used, scheduling system 150 marks the resource as blocked (under “Status” in table 300) in accordance with the state diagram of FIG. 4A. MR101 is shown available at time instance 460 as per the schedule data in row 361 of FIG. 3B. The same resource MR101 is again allocated to another set of user with the wait duration of 20 minutes as indicated by row 362 in table 350 of FIG. 3B.

Scheduling system 150 accordingly checks the usage of resource MR101 from time instance 465. Upon determining that resource MR101 is not being used, the resource is marked as On Wait (under “Status” in table 300) in accordance with the state diagram of FIG. 4A. Upon the elapsing of the wait duration of 20 minutes (indicated in row 362) and determining that resource MR101 is still not being used by the allocated users U01, U02 and U03, scheduling system 150 marks the resource as “Available”, again in accordance with the state diagram of FIG. 4A.

It may be readily observed that operation of the aspects of the present disclosure causes scheduling system 150 to deallocate the resource MR101 at time instance 470, instead of deallocation at time instance 485 (the allocated end date time as per row 362 of table 350) according to the prior approach (shown by dotted line). In other words, the resource is made available for allocation between time instances 470 and 485, instead of after time instance 485 according to the prior approach. Similarly, resource APP0872 is shown made available from time instance 475 instead of from time instance 480 according to the prior approach.

Thus, scheduling system 150, extended according to several aspects of the present disclosure, facilitates scheduling of fixed number of non-sharable resources while overcoming some of the challenges noted above.

It should be appreciated that the features described above can be implemented in various embodiments as a desired combination of one or more of hardware, software, and firmware. The description is continued with respect to an embodiment in which various features are operative when the software instructions described above are executed.

7. Digital Processing System

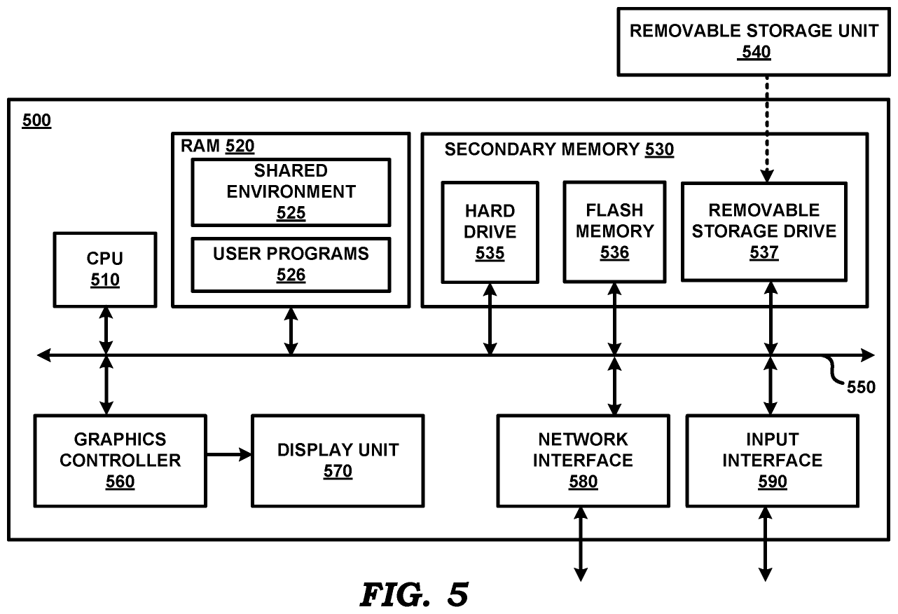

FIG. 5 is a block diagram illustrating the details of digital processing system 500 in which various aspects of the present disclosure are operative by execution of appropriate executable modules. Digital processing system 500 may correspond to scheduling system 150.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting shared environment 525 and/or other user programs 526 (such as other applications, DBMS, etc.). In addition to shared environment 525, RAM 520 may contain other software programs such as device drivers, virtual machines, etc., which provide a (common) run time environment for execution of other/user programs.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 580 provides connectivity to a network (e.g., using Internet Protocol), and may be used to communicate with other systems (of FIG. 1) connected to the networks (120 and 140).

Secondary memory 530 may contain hard drive 535, flash memory 536, and removable storage drive 537. Secondary memory 530 may store the data (for example, data portions shown in FIGS. 3A and 3B, etc.) and software instructions (for example, for implementing the various features of the present disclosure as shown in FIG. 2, etc.), which enable digital processing system 500 to provide several features in accordance with the present disclosure. The code/instructions stored in secondary memory 530 may either be copied to RAM 520 prior to execution by CPU 510 for higher execution speeds, or may be directly executed by CPU 510.

Some or all of the data and instructions may be provided on removable storage unit 540, and the data and instructions may be read and provided by removable storage drive 537 to CPU 510. Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

8. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A computer implemented method for scheduling of a fixed number of non-sharable resources, said method comprising:
maintaining a schedule data specifying respective durations in which a non-sharable resource is allocated to corresponding sets of users;
checking in a first duration whether said non-sharable resource is being used by a first set of users specified in said schedule data; and
deallocating said non-sharable resource from said first set of users within said first duration if said checking determines that said non-sharable resource is not being used by said first set of users.

2. The computer implemented method of claim 1, wherein said first duration is between a start time instance and an end time instance, wherein said deallocating is performed at a first time instance prior to said end time instance,
whereby said non-sharable resource is made available for allocation between said first time instance and said end time instance.

3. The computer implemented method of claim 2, wherein said schedule data further specifies a wait duration for said first set of users,
wherein said deallocating is performed after elapsing of said wait duration from said start time instance.

4. The computer implemented method of claim 3, wherein said checking determines that said non-sharable resource is being used by a second set of users, wherein said deallocating is performed if said second set of users does not have any users in common with said first set of users.

5. The computer implemented method of claim 2, further comprising receiving a corresponding heartbeat signal indicating that said non-sharable resource is being used at a respective time instance,
wherein said checking determines that said non-sharable resource is not being used if said corresponding heartbeat signal is not received at said first time instance.

6. The computer implemented method of claim 6, wherein said receiving also receives a data indicating a specific set of users using said non-sharable resource,
wherein said checking determines that said non-sharable resource is not being used if said specific set of users does not match said first set of users.

7. The computer implemented method of claim 6, wherein said receiving receives said corresponding heartbeat signal and said data from a IoT (Internet of things) device associated with said non-sharable resource.

8. The computer implemented method of claim 7, wherein said non-sharable resource is a meeting room, wherein IoT (Internet of things) device associated with said meeting room is a camera performing facial recognition.

9. A non-transitory machine readable medium storing one or more sequences of instructions for scheduling of a fixed number of non-sharable resources, wherein execution of said one or more instructions by one or more processors contained in a digital processing system causes said digital processing system one or more processors to perform the actions of:
maintaining a schedule data specifying respective durations in which a non-sharable resource is allocated to corresponding sets of users;
checking in a first duration whether said non-sharable resource is being used by a first set of users specified in said schedule data; and
deallocating said non-sharable resource from said first set of users within said first duration if said checking determines that said non-sharable resource is not being used by said first set of users.

10. The non-transitory machine readable medium of claim 9, wherein said first duration is between a start time instance and an end time instance, wherein said deallocating is performed at a first time instance prior to said end time instance,
whereby said non-sharable resource is made available for allocation between said first time instance and said end time instance.

11. The non-transitory machine readable medium of claim 9, wherein said schedule data further specifies a wait duration for said first set of users,
wherein said deallocating is performed after elapsing of said wait duration from said start time instance.

12. The non-transitory machine readable medium of claim 11, wherein said checking determines that said non-sharable resource is being used by a second set of users, wherein said deallocating is performed if said second set of users does not have any users in common with said first set of users.

13. The non-transitory machine readable medium of claim 10, further comprising one or more instructions for receiving a corresponding heartbeat signal indicating that said non-sharable resource is being used at a respective time instance,
wherein said checking determines that said non-sharable resource is not being used if said corresponding heartbeat signal is not received at said first time instance.

14. The non-transitory machine readable medium of claim 13, wherein said receiving also receives a data indicating a specific set of users using said non-sharable resource,
wherein said checking determines that said non-sharable resource is not being used if said specific set of users does not match said first set of users.

15. A digital processing system comprising:
one or more processors; and
a random access memory (RAM) to store instructions, wherein said one or more processors retrieve said instructions and execute said instructions, wherein execution of said instructions causes said digital processing system to perform the actions of:
maintaining a schedule data specifying respective durations in which a non-sharable resource is allocated to corresponding sets of users;
checking in a first duration whether said non-sharable resource is being used by a first set of users specified in said schedule data; and
deallocating said non-sharable resource from said first set of users within said first duration if said checking determines that said non-sharable resource is not being used by said first set of users.

16. The digital processing system of claim 15, wherein said first duration is between a start time instance and an end time instance, wherein said digital processing system performs said deallocating at a first time instance prior to said end time instance,
whereby said non-sharable resource is made available for allocation between said first time instance and said end time instance.

17. The digital processing system of claim 16, wherein said schedule data further specifies a wait duration for said first set of users,
wherein said digital processing system performs said deallocating after elapsing of said wait duration from said start time instance.

18. The digital processing system of claim 17, wherein said digital processing system determines that said non-sharable resource is being used by a second set of users, wherein said digital processing system performs said deallocating if said second set of users does not have any users in common with said first set of users.

19. The digital processing system of claim 16, further performing the actions of receiving a corresponding heartbeat signal indicating that said non-sharable resource is being used at a respective time instance,
wherein said digital processing system determines that said non-sharable resource is not being used if said corresponding heartbeat signal is not received at said first time instance.

20. The digital processing system of claim 19, wherein said digital processing system also receives a data indicating a specific set of users using said non-sharable resource,
wherein said digital processing system determines that said non-sharable resource is not being used if said specific set of users does not match said first set of users.
